(19) United States
(12) Patent Application Publication
(10) Pub. No.: US 2002/0109662 A1
(43) Pub. Date: Aug. 15, 2002

(54) Dual-screen computer display

(76) Inventor: Leighton Thomas Miller, Kailua-Kona, HI (US)

Correspondence Address: CHARLES G. CALL, 68 HORSE POND ROAD, WEST YARMOUTH, MA, 02673-2516, US

(21) Appl. No.: 09/781,711

(22) Filed: Feb. 12, 2001

(51) Int. Cl. G09G 3/36

(52) U.S. Cl. 345/100

(57) ABSTRACT

A dual screen computer output display consisting of two display panels which may be positioned in different viewing positions, including a back-to-back group presentation position in which the two screens face in opposite directions, or in a over-and-under or side-by-side enlarged viewing positions in which the two screens face in the same direction to provide an enlarged viewing area. The video controller and software produce duplicate images on the two screens in the group presentation position and produce a single enlarged image which is displayed on the the combined screens in the enlarged viewing positions. The dual screen display may be advantageously integrated with a laptop computer, together forming a folding structure which acts as a lid covering the keyboard and control surface of the laptop computer in a storage position.

### FIELD OF THE INVENTION

This invention relates to computer displays and more particularly, although in its broader aspects not exclusively, to a displays for use with laptop computers.

### BACKGROUND OF THE INVENTION

Laptop computers, because of their portability, are widely used as presentation devices. Although a laptop computer can be connected to a projection system to display images to a large group, such additional equipment is bulky, awkward to connect and set up, and hence seldom used in one-on-one settings or when making a presentation to small groups. Instead, the “audience” is typically asked to sit or stand near the computer operator so that the laptop screen may be viewed by both the operator and those witnessing the presentation. There is accordingly a need for a compact, easily transported display system that would permit the laptop operator and those to whom a computer-generated presentation is being made to view the display without leaving their seats and disrupting a face-to-face conferral.

Typically, the display screens used in laptop computers are typically included as a integral part of the lid which closes to cover the laptop's keyboard and control surface. Accordingly, the size of the display screen is inherently limited, even though in many applications a larger display screen would be desirable. There is accordingly a further need to provide the laptop user with a larger display screen that may be used to produce a larger viewing area.

### BRIEF SUMMARY OF THE INVENTION

In a principal aspect, the present invention takes the form of a computer output monitor consisting of two separate display screens and mounting means for positioning the two screens in a back-to-back relationship so that the viewing screens face in opposite directions, allowing the displayed image to be viewed on both sides of the monitor, eliminating the need to gather around the operator to view a single screen.

As contemplated by the invention, the two screens may be movably attached to the housing of a laptop computer. The screens may be folded face-to-face to form a lid structure which covers the laptop's keyboard and control surface. The lid structure may then be opened and the two screens moved into a back-to-back position such that one screen faces the operator of the keyboard and the second screen faces an audience positioned on the opposing side of the computer from the operator.

As further contemplated by the invention, the two screens may be positioned so that both screens face in the same direction, forming a combined screen area which doubles the image size presented. Screen driver electronics provides switchable mode settings, displaying a duplicate image on each screen in a group presentation mode when the screens face in opposite directions, and dividing a single image between the two screens to form a single enlarged image when the two screens face in the same direction.

The display monitor contemplated by the invention thus provides a convenient dual-screen display of a presentation image that, in the first mode, is visible to both the computer operator and an audience positioned on the other side of the computer while, in the second mode, providing a larger viewable screen area combining viewing area of the two screens.

These and other objects, features and advantages of the present invention may be more easily understood by considering the following detailed description of a specific embodiment of the invention. In the course of this description, frequent reference will be made to the accompanying drawings.

### BRIEF DESCRIPTION OF THE SEVERAL VIEWS OF THE DRAWING

FIG. 1 illustrates a laptop computer housing having a lid, shown in the closed position, which consists of two display panels;

FIG. 2 illustrates the laptop computer with the dual panels positioned in a group presentation position in which one screen faces the keyboard operator and the other screen faces in the opposite direction;

FIG. 3 depicts a second mode in which the dual screen panels both face the keyboard operator to form an double-sized viewing area;

FIG. 4 is a side elevation view of the laptop computer showing the manner in which the two screens are movably attached to one another to permit them to be folded into a closed position as a housing lid, unfolded to a first position for use as a double-sized screen, and further unfolded into a group presentation position for viewing on both sides of the computer.

FIG. 5 illustrates the dual screen display system of the invention detached from the computer housing and unfolded into a group presentation position for two-sided viewing and a book-viewing position with the two panels displaying either side-by-side portrait mode images or a single enlarged image.

FIG. 6 depicts the manner in which duplicate images are displayed on the dual screens for correct orientation when the display is in the group presentation position seen in FIGS. 2 and 5;

FIG. 7 shows how a single portrait mode image is displayed on the two screens when in the side-by-side position depicted in FIG. 3; and

FIG. 8 illustrates the manner in which a single image is displayed on the screen when detached and positioned in the book-viewing position illustrated by the dashed lines in FIG. 5.

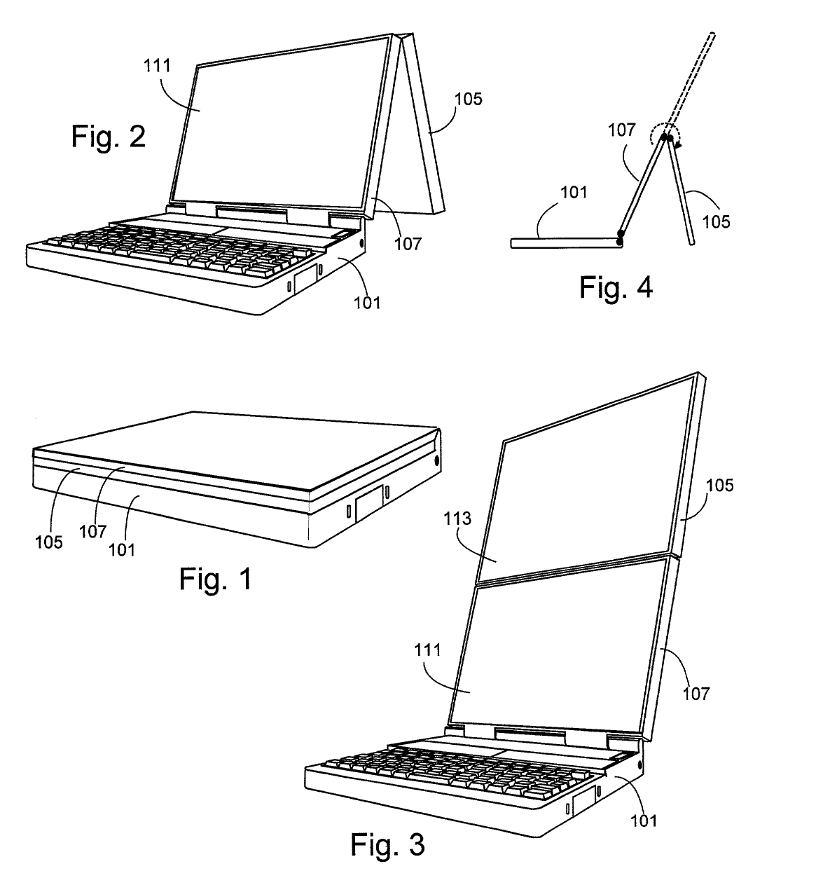

### DETAILED DESCRIPTION OF THE INVENTION

The dual screen display system may be used to particular advantage when integrated with the housing of an laptop computer as illustrated by the specific embodiment which is described below. It is to be understood, however, that the principles of the invention may be used to advantage in a variety of other forms; for example, the dual screen monitor may be a separate peripheral device connected to the video output port of a conventional computer.

In accordance with the invention, the display system is movably attached to the main body housing 101 of a laptop computer. The display system consists of two display panels 105 and 107. A long edge of display panel 105 is attached parallel to and adjacent with a long edge of display panel 105 which is in turn attached to the housing 101.

A first display screen 111 is exposed for viewing on one major surface of the panel 107 and a viewing screen 113 (visible in FIG. 3) is exposed on one major surface of the display panel 105.

As shown in Fig, the panels 105 and 107 may be moved into a folded storage position, with the viewing screens 111 and 113 in face-to-face relation and with panel 105 sandwiched between the panel 107 and the housing 101, thus forming a lid covering the keyboard and control surface of the housing 101. In the storage position, the viewing screens are protected against damage.

The panels 105 and 107 may be unfolded and placed in the double screen viewing position that is illustrated in FIG. 3 of the drawings. In this position, the viewing screens 111 and 113 are in the same plane and face in the same direction for viewing by the keyboard operator to provide an enlarged, double-screen over-and-under viewing area. The video controller within the laptop delivers a single image which is jointly displayed on the double screen area as illustrated in FIG. 7.

The panel 105 may be pivoted further into a back-to-back relationship to the panel 107 so that the viewing screens 111 and 113 face in opposite directions as seen in FIG. 2. Each viewing screen 111 and 113 displays the same image, with the image on screen 113 being flipped vertically as illustrated in FIG. 6 so that both images are right-side-up when the panels are in the group presentation position. In this group presentation position, the keyboard operator may view the same image on screen 111 that an audience seated on the other side of the computer sees on the screen 113. In this way, the operator may have a face to face conversation with the audience and both the operator and the audience can view the computer generated image on the screen that faces them. The positions of the panels 105 and 107 with respect to the housing 101 are shown by the solid lines in the side elevation view of FIG. 4, while the position of panel 105 in the double-screen position of FIG. 3 is shown by dashed lines in FIG. 4.

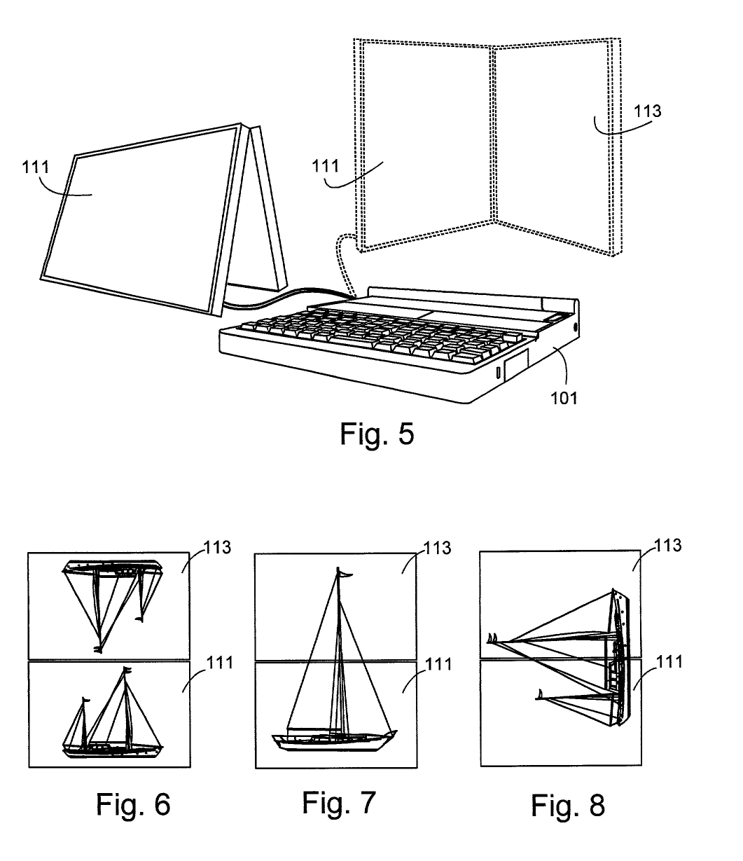

As illustrated in FIG. 5, the panels 105 and 107 may also be detached from the laptop and connected to the electronics in the housing 101 by an umbilical cable 155. Alternatively, the dual panel monitor may be plugged into the conventional video output port of any computer. The display panels may be positioned as in a back-to-back presentation position for viewing from two different sides as shown at 501 in FIG. 5, may be positioned as an enlarged over-and-under screen (as seen in FIG. 3 but not shown in FIG. 5), or may be positioned in an open-book positionwith the edge joining panels 105 and 107 being positioned vertically so that the viewing screens 111 and 113 are viewed like the right hand and left hand pages of a book as illustrated by the dashed lines in FIG. 5. When positioned as seen at 505 in open-book position, the viewing screens 111 and 113 display a single large image as illustrated in FIG. 8.

One or more suitable video controllers of conventional design are combined with the processor, memory and other conventional circuitry within the housing 101. A single video controller may be used in combination with separate drivers to generate identical images on the two screens 111 and 113 as illustrated in FIG. 6. As described in U.S. Pat. No. 6,118,413 which issued to Bril et al. on Sep. 12, 2000, a single video controller may be used to control the two separate displays with separate images, refresh rates and pixel resolutions. The orientation of the image presented on each screen, or on the combined screens, may be controlled by a conventional video controller using a software driver using control parameters which determine where each successive pixel of information goes in the display memory. These parameters are set at the time an orientation mode is selected, and the use of these parameters by the driver allows the same instructions to be used for each mode. Suitable software drivers are available from Portrait Displays, Inc. of Piscataway, N.J. and are described in U.S. Pat. No. 5,973,664 issued to A. E. Badger on Oct. 26, 1999.

It is to be understood that the specific embodiment of the invention which has been described is merely one illustrative application of the principles of the invention. Numerous modifications may be made to the arrangement described without departing from the true spirit and scope of the invention.

What is claimed is:

1. A computer output monitor comprising two separate display screens and mounting means for positioning said screens in back-to-back relation to one another to present separate display images visible by different viewers on opposing sides of said monitor.

2. A computer output monitor as set forth in claim 1 wherein said mounting means permits the relative movement of said separate screens between a first exposed viewing position in which said screens are in said back-to-back relation to one another and second inactive position in which said screens are in a face-to-face relation to one another for storage.

3. A computer output monitor as set forth in claim 2 wherein said mounting means permits the relative movement of said separate screens to a third exposed viewing position in which said display screens are positioned adjacent to one anther in a side-by-side relation for viewing by a single viewer.

4. A computer output monitor as set forth in claim 1 wherein said display screens are connected to receive display image data from a laptop computer and wherein said mounting means attaches said display screens to the body of said laptop computer such that one of said display screens is viewable by the operator of said laptop computer and the second of said display screens is viewable by another person positioned on the other side of said laptop computer from said operator.

5. A computer output monitor as set forth in claim 4 wherein said laptop computer includes a keyboard and wherein said mounting means permits the relative movement of said separate screens between a first exposed viewing position in which said screens are in said back-to-back relation to one another and second inactive position in which said screens are secured over said keyboard in a face-to-face relation to one another for storage.

6. A computer output monitor as set forth in claim 5 wherein said mounting means permits the relative movement of said separate screens to a third exposed viewing position in which said display screens are positioned adjacent to one anther in a side-by-side relation for viewing by said operator.

7. A laptop computer comprising, in combination, a computer housing, a keyboard mounted on one face of said housing, a first display panel exposing a first active viewing screen on one face thereof, a second display panel exposing a second active viewing screen on one face thereof, means for moveably attaching said first and second panels to said housing such that, in a first viewing position, said panels are positioned in back-to-back relationship to one another so that one of said first viewing screens is visible to the operator of said keyboard and the second of said viewing screens is visible to a person on the other side of said laptop computer from said operator.

8. A display system comprising a computer for concurrently generating data for producing first and second images, first and second display panels coupled to receive said data from said computer, each of said panels having viewing screen surface for displaying an image and an opposing back surface, mounting means for attaching said panel displays for relative movement between a folded storage position in which the viewing screen surfaces of said first and second panels positioned are in a protected face-to-face position and a unfolded viewing position in which said panels are in a back-to-back position with one of said viewing screens being visible on one side of said display system and the other of said viewing screens being visible on the other side of said display system.
